(19) United States
(12) Patent Application Publication
(10) Pub. No.: US 2009/0036222 A1
(43) Pub. Date: Feb. 5, 2009

(54) Pivotal Device for Universal Joint

(76) Inventor: Bobby Hu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/869,066

(22) Filed: Oct. 9, 2007

(30) Foreign Application Priority Data
Jul. 31, 2007 (TW) 96128086

(51) Int. Cl. F16D 3/06

(52) U.S. Cl. 464/118

(57) ABSTRACT

A universal joint includes first and second yoke members each having a pair of spaced arms. A coupler includes a positioning hole in which an engaging member is received. Two pair of pins are extended through the arms of the first and second yoke member and through pin holes of the coupler into the positioning hole, allowing the first and second yoke members to respectively pivot about first and second pivot axes that are perpendicular to and intersect each other. The engaging member is movable between an engaged position engaged with the four pins and a free position disengaged from the four pins allowing detachment of the four pins.

### BACKGROUND OF THE INVENTION

The present invention relates to a pivotal device and, more particularly, to a pivotal device for a universal joint that is more reliable and that allows easy replacement when desired.

Various universal joints exist for providing power transmission from a power source to a member to be driven. FIG. 6 shows a conventional universal joint 70 including a pair of yoke members 73 and 75 and a cubic coupler 71. The yoke member 75 includes a power input end 96, and the other yoke member 73 includes a power output end 77 for coupling with a socket. The coupler 71 includes a first through-hole 78 extending through a pair of opposite faces thereof and a second through-hole 79 extending through another pair of opposite faces thereof. The second through-hole 79 is orthogonal to and intersects the first through-hole 78. The coupler 71 is pivotably coupled with the yoke member 75 by extending a first pin 74 through aligned pin holes 750 in the yoke member 75 and the first through-hole 78 of the coupler 71. The first pin 74 includes two diametrically opposed grooves 742 in an outer periphery thereof and a transverse through-hole 740 extending through bottom walls of the grooves 742. A bushing 720 is extended through each of a pair of aligned pin holes 730 of the yoke member 73 into the second through-hole 79 of the coupler 71. Each bushing 720 includes an inner end having a protrusion 724 engaged in one of the grooves 742 of the first pin 74. A second pin 72 is extended through a longitudinal hole 722 in each bushing 720 and the transverse through-hole 740 of the first pin 74. Thus, the coupler 71 is pivotably coupled with the yoke member 73. Assembly and disassembly of the universal joint 70 are troublesome. Manufacturing of the different pins 74 and 72 are costly, and replacement of the different pins 74 and 72 is inconvenient.

U.S. Pat. No. 3,930,381 discloses a universal joint including a pair of yoke members coupled together by a block that is split into two halves along a bisecting plane parallel to the axially opposite end faces of the block, the latter being bored axially to receive a bolt and a cooperating nut for clamping the two block sections together. Each yoke member includes a pair of arms having aligned apertures in which sleeve bearings are mounted. Four stub shafts are rotatably received in the sleeve bearings and couple the block with the arms of the yoke members. Each stub shaft has an enlarged head or rim, and the interior of the split block is hollowed to provide a shouldered recess for the head portions to retain the stub shafts against escape laterally outward of the block. Assembly and disassembly of such a universal joint is troublesome due to its complicated structure.

It is, therefore, a need in a pivotal device for a universal joint that provides a reliable structure to avoid disengagement of pins while allowing easy replacement when desired.

### BRIEF SUMMARY OF THE INVENTION

The present invention solves this need and other problems in the field of power transmission by providing, in a preferred form, a universal joint including first and second yoke members. The first yoke member includes a power input end, and the second yoke member includes a power output end. Each of the first and second yoke members further includes a coupling end having a pair of spaced arms with aligned pivot holes. The universal joint further includes a coupler having a positioning hole in a face thereof. The coupler further includes two first pin holes respectively formed in each of a first pair of opposite faces of the coupler perpendicular to the face having the positioning hole. The coupler further includes two second pin holes respectively formed in each of a second pair of opposite faces of the coupler perpendicular to the first pair of opposite faces and 8 the face having the positioning hole. Each of the first and second pin holes are in communication with the positioning hole. First and second pins are respectively extended through the pivot holes of the arms of the first yoke member and through the first pin holes of the coupler into the positioning hole, allowing the first yoke member to pivot relative to the coupler about a first pivot axis defined by the first and second pins. Third and fourth pins are respectively extended through the pivot holes of the arms of the second yoke member and through the second pin holes of the coupler into the positioning hole, allowing the second yoke member to pivot relative to the coupler about a second pivot axis defined by the third and fourth pins. The second pivot axis is perpendicular to and intersects the first pivot axis. An engaging member is mounted in the positioning hole of the coupler and movable between an engaged position engaged with the first, second, third, and fourth pins and a free position disengaged from the first, second, third, and fourth pins allowing detachment of the first, second, third, and fourth pins.

In the most preferred forms the engaging member includes an inner end having an engaging hole defined by a peripheral edge. The engaging member further includes an outer end having a hole for coupling with a tool for moving the engaging member between the engaged position and the free position. The first, second, third, and fourth pins are identical and each include an inner end having a groove and a coupling section having substantially quarter circular cross sections. The coupling sections of the first, second, third, and fourth pins together form a cylinder having circular cross sections. When the engaging member is in the engaged position, the coupling sections of the first, second, third, and fourth pins are engaged in the engaging hole of the engaging member whereas the peripheral edge of the engaging member is engaged in the grooves of first, second, third, and fourth pins.

The first, second, third, and fourth pins of the universal joint according to the preferred teachings of the present invention are reliably engaged with the engaging member in the engaged position to allow high-speed rotation without the risk of disengagement. Furthermore, the first, second, third, and fourth pins of the universal joint according to the preferred teachings of the present invention can be easily and rapidly detached for replacement purposes.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a perspective view of a universal joint with a pivotal device according to the preferred teachings of the present invention.

FIG. 2 shows an exploded perspective view of the universal joint of FIG. 1.

FIG. 3 shows a cross sectional view of the universal joint of FIG. 1 according to section line 3-3 of FIG. 1.

FIG. 4 shows a cross sectional view of the universal joint of FIG. 1 according to section line 4-4 of FIG. 1.

FIG. 5 shows a cross sectional view of the universal joint of FIG. 1 according to section line 5-5 of FIG. 4.

FIG. 6 shows an exploded perspective view of a conventional universal joint.

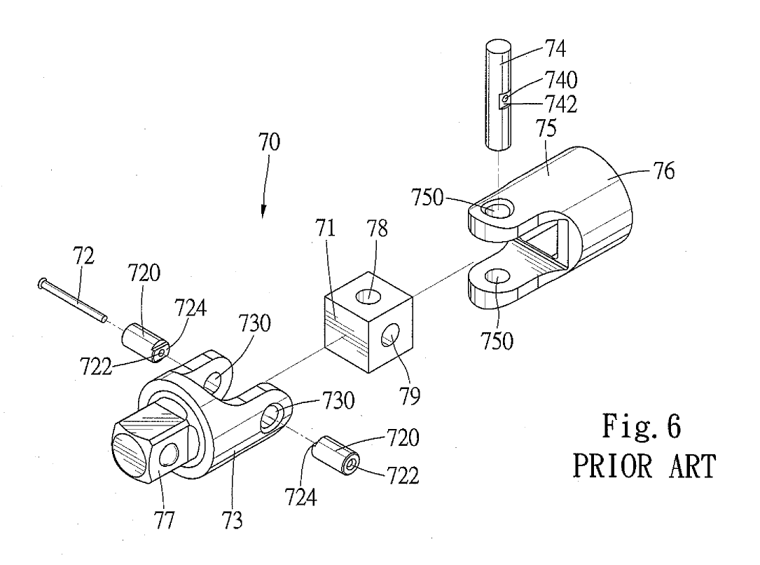

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “third”, “fourth”, “end”, “portion”, “section”, “centrifugal”, “lateral”, “peripheral”, “inward”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

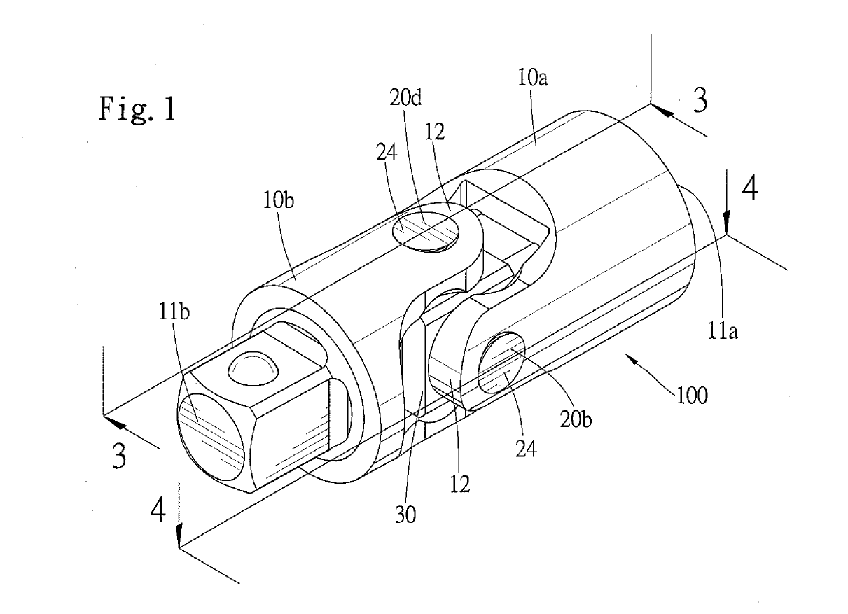

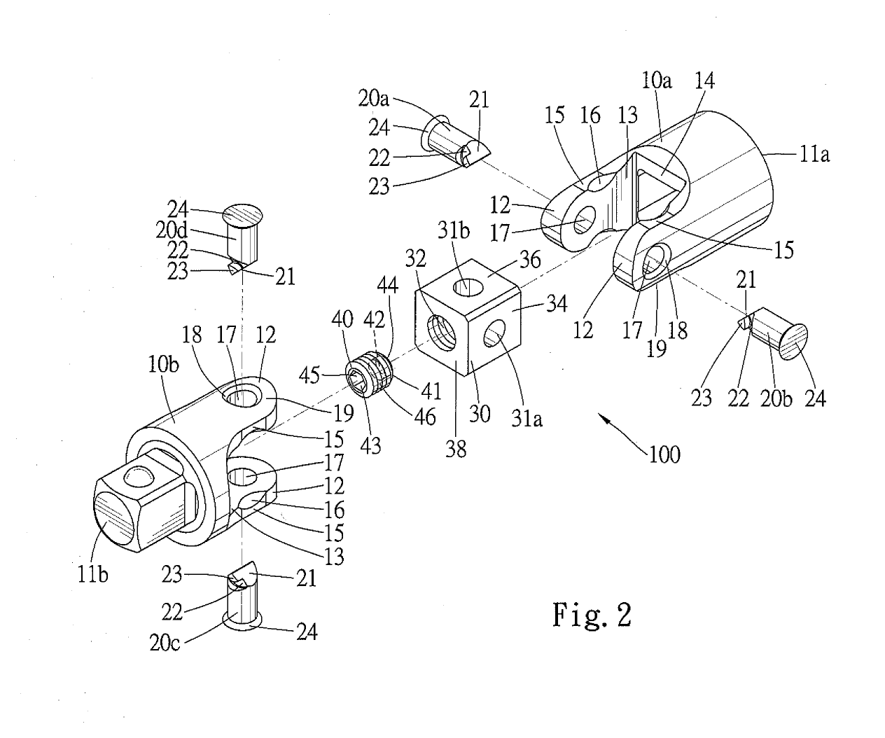

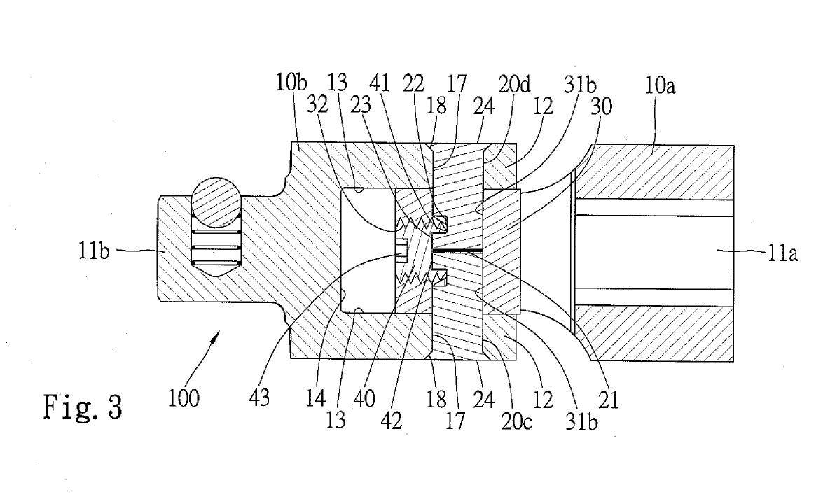

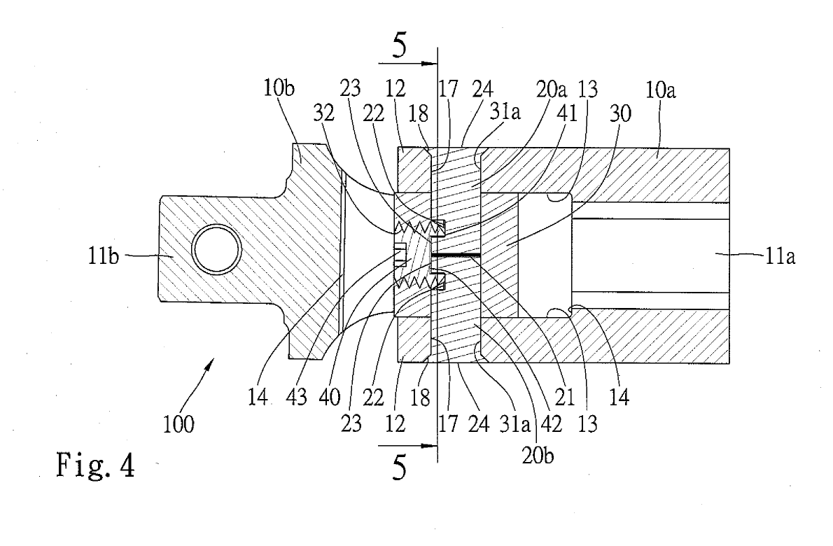

A universal joint with a pivotal device according to the preferred teachings of the present invention is shown in FIGS. 1-5 of the drawings and designated 100. The universal joint 100 includes first and second yoke members 10a and 10b. In the preferred form shown, the first yoke member 10a includes a coupling end 19 and a power input end 11a in the form of a socket for coupling with a power tool for high speed operations. Other forms of the power input end 11a would be within the skill of the art. The second yoke member 10b includes a coupling end 19 and a power output end 11b in the form of a drive column for coupling with a socket. Other forms of the power output end 11b would be within the skill of the art. In the most preferred form shown, the coupling ends 19 of the first and second yoke members 10a and 10b are identical. Thus, description of one of the coupling ends 19 would be sufficient.

In the most preferred form shown, the coupling end 19 includes a pair of spaced arms 12 having aligned pivot holes 17 and mutually facing inner faces 13 interconnected by an intermediate face 14 therebetween. Each arm 12 further has two opposite lateral sides 15 between which one of the inner faces 13 extends. A recess 16 is formed between each lateral side 15 of each arm 12 and one of the inner faces 13 of the arm 12. Each recess 16 is located between the intermediate face 14 of a pair of the arms 12 and a pivot axis extending through the pivot holes 17 of the pair of arms 12. During transmission of power, the recesses 16 of each yoke member 10a, 10b receive the arms 12 of the other yoke member 10b, 10a. Thus, the angle between the first and second yoke members 10a and 10b can be larger. Namely, the working angle range of the universal joint according to the preferred teachings of the present invention is wider than conventional ones. Each pivot hole 17 includes an outer end with a larger receiving section 18 that has an inner diameter greater than that of the pivot hole 17.

In the preferred form shown, the coupler 30 is a cube with six faces and includes a positioning hole 32 in a face 38 thereof In the most preferred form shown, the positioning hole 32 is a screw hole with inner threading. The coupler 30 further includes two first pin holes 31 a respectively extending inward from a first pair of opposite faces 34 perpendicular to the face 38 with the positioning hole 32. The first pin holes 31a are aligned with each other and in communication with the positioning hole 32. The coupler 30 further includes two second pin holes 31b respectively extending inward from a second pair of faces 36 perpendicular to the first pair of opposite faces 34 and perpendicular to the face 38 with the positioning hole 32. The second pin holes 31b are aligned with each other and in communication with the positioning hole 32. A first central axis extending through the aligned first pin holes 31a is coplanar with and orthogonal to a second central axis extending through the second pin holes 31b.

A first pin 20a is extended through the pivot hole 17 of one of the arms 12 of the first yoke member 10a and through one of the first pin holes 31a of the coupler 30 into the positioning hole 32 of the coupler 30. A second pin 20b is extended through the pivot hole 17 of the other arm 12 of the first yoke member 10a and through the other first pin hole 31a of the coupler 30 into the positioning hole 32 of the coupler 30. Thus, the first yoke member 10a is pivotable relative to the coupler 30 about a first pivot axis defined by the first and second pins 20a and 20b. A third pin 20c is extended through the pivot hole 17 of one of the arms 12 of the second yoke member 10b and through one of the second pin holes 31b of the coupler 30 into the positioning hole 32 of the coupler 30. A fourth pin 20d is extended through the pivot hole 17 of the other arm 12 of the second yoke member 10b and through the other second pin hole 31b of the coupler 30 into the positioning hole 32 of the coupler 30. Thus, the second yoke member 10b is pivotable relative to the coupler 30 about a second pivot axis defined by the third and fourth pins 20c and 20d. The second pivot axis is perpendicular to and intersects the first pivot axis.

In the most preferred form shown, the first, second, third, and fourth pins 20a, 20b, 20c, and 20d are identical to each other to allow easy replacement. Each of the first, second, third, and fourth pins 20a, 20b, 20c, and 20d includes an inner end 21 having a groove 22 in an outer periphery thereof and a coupling section 23 having substantially quarter circular cross sections. The first, second, third, and fourth pins 20a, 20b, 20c, and 20d may be formed by any suitable method including but not limited to machining, milling, casting, injection molding, etc. Each coupling section 23 is located on the outer periphery of the inner end 21 of the pin 20a, 20b, 20c, 20d and faces an outer end of the positioning hole 32 of the coupler 30. Each of the first, second, third, and fourth pins 20a, 20b, 20c, and 20d includes an enlarged outer end 24 fittingly received in the receiving section 18 of one of the arms 12 of one of the first and second yoke members 10a and 10b so that the outer end 24 does not extend beyond the outer face of the arm 12.

An engaging member 40 is mounted in the positioning hole 32 of the coupler 30. In the most preferred form shown, the engaging member 40 includes outer threading 46 for threadedly engaging with the inner threading of the positioning hole 32. The engaging member 40 further includes an inner end 41 having an engaging hole 42 defined by a peripheral edge 44. Furthermore, the engaging member 40 includes an outer end 43 having a hexagonal groove 45 for coupling with a hexagonal wrench or the like so that the engaging member 40 can be moved in the positioning hole 32 of the coupler 30 between an engaged position engaged with the first, second, third, and fourth pins 20a, 20b, 20c, and 20d and a free position disengaged from the first, second, third, and fourth pins 20a, 20b, 20c, and 20d. Specifically, when the engaging member 40 is in its engaged position, the coupling sections 23 of the first, second, third, and fourth pins 20a, 20b, 20c, and 20d are engaged with the engaging hole 42 of the inner end 41 of the engaging member 40 whereas the peripheral edge 44 of the inner end 41 of the engaging member 40 is engaged with the grooves 22 of the first, second, third, and fourth pins 20a, 20b, 20c, and 20d. Thus, the first, second, third, and fourth pins 20a, 20b, 20c, and 20d are securely engaged with the engaging member 40 such that disengagement of the first, second, third, and fourth pins 20a, 20b, 20c, and 20d from the coupler 30 is avoided. On the other hand, when the engaging member 40 is moved to the free position, the coupling sections 23 of the first, second, third, and fourth pins 20a, 20b, 20c, and 20d are disengaged from the engaging hole 42 of the inner end 41 of the engaging member 40 whereas the peripheral edge 44 of the inner end 41 of the engaging member 40 is disengaged from the grooves 22 of the first, second, third, and fourth pins 20a, 20b, 20c, and 20d. Thus, the first, second, third, and fourth pins 20a, 20b, 20c, and 20d are disengaged from the engaging member 40 and, thus, removable for repair or replacement purposes.

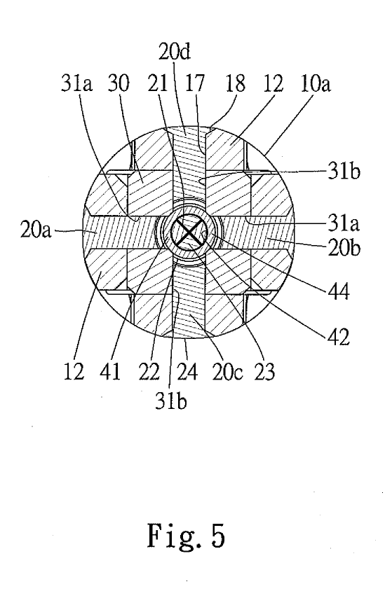

Now that the basic construction of the universal joint 100 of the preferred teachings of the present invention has been explained, the operation and some of the advantages of the universal joint 100 can be set forth and appreciated. When the power input end 11a of the first yoke member 10a is rotated by a power tool, the power is transmitted to the second yoke member 10b for driving a socket for tightening/loosening a fastener or the like. The recesses 16 of the arms 12 of one of the first and second yoke members 10a and 10b can receive the arms 12 of the other yoke member 10a or 10b during power transmission, allowing a larger working angle between the first and second yoke members 10a and 10b. The universal joint 100 according to the preferred teachings of the present invention can be utilized with high-speed power tools due to the reliable engagement between the coupling sections 23 of the first, second, third, and fourth pins 20a, 20b, 20c, and 20d and the engaging hole 42 of the inner end 41 of the engaging member 40 and reliable engagement between the peripheral edge 44 of the inner end 41 of the engaging member 40 and the grooves 22 of the first, second, third, and fourth pins 20a, 20b, 20c, and 20d. It can be appreciated that the coupling sections 23 of the first, second, third, and fourth pins 20a, 20b, 20c, and 20d together form a cylinder having circular cross sections (see FIG. 5). Undesired disengagement of the first, second, third, and fourth pins 20a, 20b, 20c, and 20d from the coupler 30 is avoided even though the universal joint 100 operates at high speed and is, thus, subjected to high centrifugal force. Thus, the coupler 30, the engaging member 40, the coupling ends 19 of the first and second yoke members 10a and 10b, and the first, second, third, and fourth pins 20a, 20b, 20c, and 20d together form a reliable pivotal device.

Now that the basic teachings of the present invention have been explained, many extensions and variations will be obvious to one having ordinary skill in the art. For example the coupling ends 19 of the first and second yoke members 10a and 10b can be different in shapes. Similarly, the pins 20a, 20b, 20c, and 20d can be different in shapes. The power input end 11a of the first yoke member 10a can be manually driven or through a coupling member when desired.

The universal joint 100 according to the preferred teachings of the present invention can rapidly and reliably be assembled without the risk of disengagement of the pins 20a, 20b, 20c, and 20d. Furthermore, the universal joint 100 according to the preferred teachings of the present invention can be utilized with high-speed power tools and work in a larger working angle. When replacement is required, the universal joint 100 according to the preferred teachings of the present invention can rapidly be detached to allow easy, rapid replacement of broken or damaged parts without discarding the whole universal joint 100.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A universal joint comprising:
a first yoke member including a power input end and a first coupling end, with the first coupling end including a pair of spaced first arms having aligned first pivot holes;
a second yoke member including a power output end and a second coupling end, with the second coupling end including a pair of spaced second arms having aligned second pivot holes;
a coupler including opposite first and second faces, opposite third and fourth faces perpendicular to the first and second faces, and a fifth face perpendicular to the first, second, third, and fourth faces, with the fifth face including a positioning hole defined therein, with the coupler further including two first pin holes respectively extending inward from the first and second faces, with the first pin holes being aligned with each other and in communication with the positioning hole, with the coupler further including two second pin holes respectively extending inward from the third and fourth faces, with the second pin holes being aligned with each other, in communication with the positioning hole, and perpendicular to the first pin holes;
first and second pins respectively extending through the first pivot holes of the first arms of the first yoke member and through the first pin holes of the coupler into the positioning hole, allowing the first yoke member to pivot relative to the coupler about a first pivot axis defined by the first and second pins;
third and fourth pins respectively extending through the second pivot holes of the second arms of the second yoke member and through the second pin holes of the coupler into the positioning hole, allowing the second yoke member to pivot relative to the coupler about a second pivot axis defined by the third and fourth pins, and with the second pivot axis being perpendicular to and intersecting the first pivot axis; and
an engaging member mounted in the positioning hole of the coupler and movable between an engaged position engaged with the first, second, third, and fourth pins and a free position disengaged from the first, second, third, and fourth pins allowing detachment of the first, second, third, and fourth pins.

2. The universal joint as claimed in claim 1, with the engaging member including an inner end having an engaging hole, with each of the first, second, third, and fourth pins including an inner end having a coupling section engaged with the engaging hole of the engaging member in the engaged position, and with the coupling sections of the first, second, third, and fourth pins being disengaged from the engaging hole of the engaging member in the free position.

3. The universal joint as claimed in claim 2, with the inner end of each of the first, second, third, and fourth pins including a groove, with the inner end of the engaging member including a peripheral edge defining the engaging hole, with the peripheral edge of the engaging member being engaged with the grooves of the first, second, third, and fourth pins when the engaging member is in the engaged position, and with the peripheral edge of the engaging member being disengaged from the grooves of the first, second, third, and fourth pins when the engaging member is in the free position.

4. The universal joint as claimed in claim 3, with the coupling sections of the first, second, third, and fourth pins together form a cylinder having circular cross sections.

5. The universal joint as claimed in claim 4, with the first, second, third, and fourth pins being identical, and with the coupling section of each of the first, second, third, and fourth pins having substantially quarter circular cross sections.

6. The universal joint as claimed in claim 1, with the positioning hole of the coupler being a screw hole, and with the engaging member including outer threading threadedly engaged with the screw hole.

7. The universal joint as claimed in claim 6, with the engaging member further including an outer end having a groove adapted to be coupled with a tool for moving the engaging member between the engaged position and the free position.

8. The universal joint as claimed in claim 1, with each of the first and second pivot holes of the first and second yoke members including an outer end with a larger receiving section having an inner diameter larger than that of the first and second pivot holes, and with each of the first, second, third, and fourth pins including an enlarged outer end received in the larger receiving section of one of the first and second arms so that the enlarged outer ends of the first, second, third, and fourth pins do not extend beyond outer faces of the first and second arms of the first and second yoke members.

9. The universal joint as claimed in claim 1, with the first arms of the first yoke member including two mutually facing first inner faces, with the first coupling end of the first yoke member further including a first intermediate face interconnected between the first inner faces, with each of the first arms of the first yoke member further including a first pair of opposite lateral sides between which one of the first inner faces extends, with a first recess being formed between each of the first pair of opposite lateral sides of each of the first arms and one of the first inner faces of one of the first arms, with each of the first recesses being located between the first pivot axis and the first intermediate face, and with the first recesses of the first yoke member allowing entrance of the second arms of the second yoke member.

10. The universal joint as claimed in claim 9, with the second arms of the second yoke member including two mutually facing second inner faces, with the second coupling end of the second yoke member further including a second intermediate face interconnected between the second inner faces, with each of the second arms of the second yoke member further including a second pair of opposite lateral sides between which one of the second inner faces extends, with a second recess being formed between each of the second pair of lateral sides of each of the second arms and one of the second inner faces of one of the second arms, with each of the second recesses being located between the second pivot axis and the second intermediate face, and with the second recesses of the second yoke member allowing entrance of the first arms of the first yoke member.
